(19) United States
(12) Patent Application Publication
(10) Pub. No.: US 2008/0239548 A1
(43) Pub. Date: Oct. 2, 2008

(54) Multiple sector reassign on write error for disk drive

(75) Inventors: Stephen G. Paul, Santa Cruz, CA (US); Dar-Der Chang, San Jose, CA (US)

Correspondence Address: SCHWEGMAN, LUNDBERG & WOESSNER/TOSHIBA, P.O. BOX 2938, MINNEAPOLIS, MN, 55402, US

(73) Assignee: TOSHIBA AMERICA INFORMATION SYSTEMS, INC., IRVINE, CA (US)

(21) Appl. No.: 11/731,217

(22) Filed: Mar. 30, 2007

(51) Int. Cl. G11B 21/02

(52) U.S. Cl. 360/75; 360/135

(57) ABSTRACT

A disk drive includes a disk for storing information representing data, and a memory device. A method for writing includes locating a first data sector on a disk where a write operation fails, identifying the first data sector and a plurality of other data sectors near the first data sector as a grown defect, and storing the location of the first data sector and the plurality of other data sectors on a grown defect list. The memory device includes a list of grown defects that identifies a plurality of data sectors stored along a track between the first servo wedge and the second servo wedge on a selected track as data sectors which may not be written to.

### TECHNICAL FIELD

Various embodiments described herein relate to apparatus, systems, and methods associated with information storage and processing including the handling of write errors in a disk drive.

### BACKGROUND

A disk drive is an information storage device. A disk drive includes one or more disks clamped to a rotating spindle, and at least one head for reading information representing data from and/or writing data to the surfaces of each disk. Disk drives also include an actuator utilizing linear or rotary motion for positioning transducing head(s) over selected data tracks on the disk(s). A rotary actuator couples a slider, on which a transducing head is attached or integrally formed, to a pivot point that allows the transducing head to sweep across a surface of a rotating disk. The rotary actuator is driven by a voice coil motor. Storing data includes writing information representing data to portions of tracks on a disk. Data retrieval includes reading the information representing data from the portion of the track on which the information representing data was stored.

When writing data or information representing data to a disk drive, there are a number of steps that occur. Information representing data is ultimately written to a very specific location on a disk surface. In many instances, information representing data is written to a portion of a track called a data sector. To write to a specific location on a disk, the position of the write element must be exactly known. Data tracks are very closely spaced and if the write head is out of position by even a portion of a track width, the write head may be writing over information representing other data. After data is overwritten, it can not be retrieved at a later time. This may result in a loss of information. Of course, a loss of data is always to be avoided in a device for storing data, such as a disk drive.

In the past, there were instances when data could not be written to certain portions of the disk. As part of manufacturing a disk drive, defects that would disallow writing to certain sectors of the disk were noted. A log or map of the defective sectors was produced and attempts to write were never made to these sectors. As further defects were found, this list of defects was added to one sector at a time. Attempts to write to the defective sectors added after manufacture also were not made.

### BRIEF DESCRIPTION OF THE DRAWINGS

The invention is pointed out with particularity in the appended claims. However, a more complete understanding of the present invention may be derived by referring to the detailed description when considered in connection with the figures, wherein like reference numbers refer to similar items throughout the figures and:

FIG. 1 is a view of a disk drive with a cover removed, according to an example embodiment described herein.

FIG. 2 is an exploded view of a disk drive, according to an example embodiment described herein.

FIG. 3 is a plan view of a disk from the disk drive shown in FIGS. 1 and 2 that includes a servo wedges and data wedges, according to an example embodiment.

FIG. 4 shows a portion of a disk and a first servo wedge and a second servo wedge, according to an example embodiment.

FIG. 5 shows a block diagram of the disk drive, according to an example embodiment.

FIG. 6 is a schematic diagram of a number of tracks in a first zone and a number of tracks in a second zone of a disk from a disk drive, in which the tracks include data sectors positioned between servo information, according to an example embodiment.

FIG. 7 is a flow chart of a method for determining a write defect and placing the defect onto the defect list, according to an example embodiment.

FIG. 8 is a representation of a defect list, according to an example embodiment.

FIGS. 9A and 9B is a flow chart of a method for determining a write defect and placing the defect onto the defect list, according to an example embodiment.

FIG. 10 is an example block diagram of a computer system for implementing functions and controllers described in accordance with example embodiments.

The description set out herein illustrates the various embodiments of the invention and such description is not intended to be construed as limiting in any manner.

### DETAILED DESCRIPTION

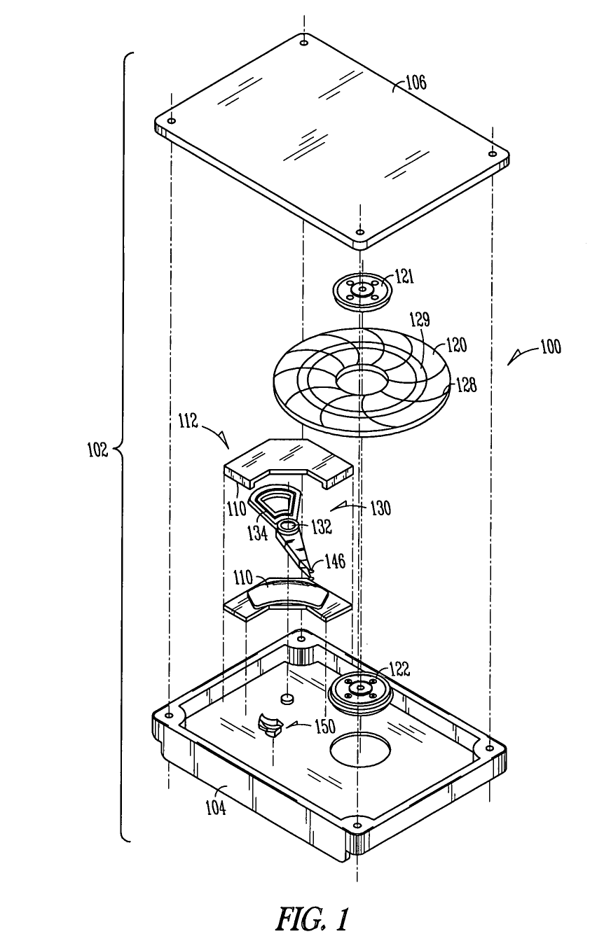

FIG. 1 is an exploded view of disk drive 100 that uses various embodiments of the present invention. The disk drive 100 includes a housing 102 including a housing base 104 and a housing cover 106. The housing base 104 illustrated is a base casting, but in other embodiments a housing base 104 can comprise separate components assembled prior to, or during assembly of the disk drive 100. A disk 120 is attached to a hub or spindle 122 that is rotated by a spindle motor. The disk 120 can be attached to the hub or spindle 122 by a clamp 121. The disk may be rotated at a constant or varying rate ranging from less than 3,600 to more than 15,000 revolutions per minute. Higher rotational speeds are contemplated in the future. The spindle motor is connected with the housing base 104. The disk 120 can be made of a light aluminum alloy, ceramic/glass or other suitable substrate, with magnetizable material deposited on one or both sides of the disk. The magnetic layer includes small domains of magnetization for storing data transferred through a transducing head 146. The transducing head 146 includes a magnetic transducer adapted to read data from and write data to the disk 120. In other embodiments, the transducing head 146 includes a separate read element and write element. For example, the separate read element can be a magneto-resistive head, also known as a MR head. It will be understood that multiple head 146 configurations can be used.

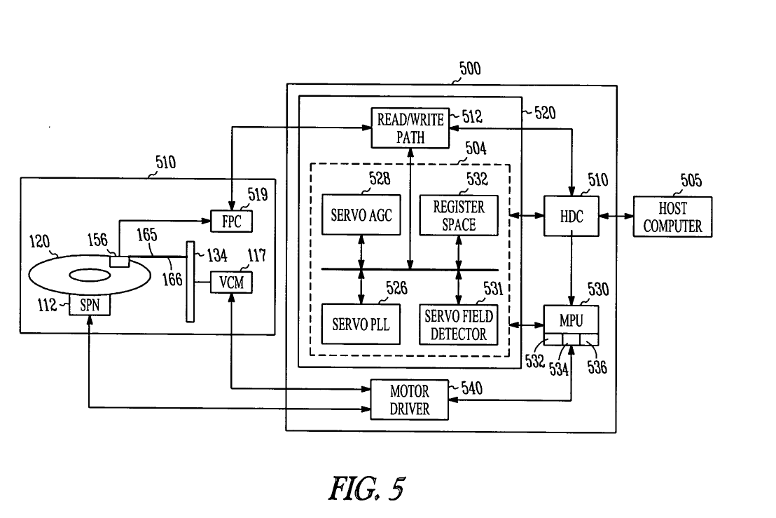

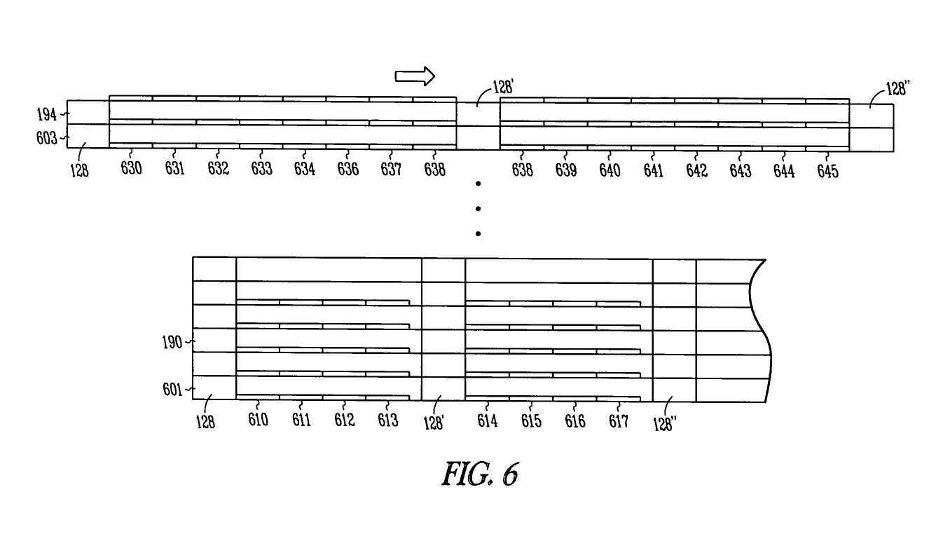

A rotary actuator 130 is pivotally mounted to the housing base 104 by a bearing 132 and sweeps an arc between an inner diameter (ID) of the disk 120 and a ramp 150 positioned near an outer diameter (OD) of the disk 120. Attached to the housing 104 are upper and lower magnet return plates 110 and at least one magnet that together form the stationary portion of a voice coil motor (VCM) 112. A voice coil 134 is mounted to the rotary actuator 130 and positioned in an air gap of the VCM 112. The rotary actuator 130 pivots about the bearing 132 when current is passed through the voice coil 134 and pivots in an opposite direction when the current is reversed, allowing for control of the position of the actuator 130 and the attached transducing head 146 with respect to the disk 120. The VCM 112 is coupled with a servo system (shown in FIG. 4) that uses positioning data read by the transducing head 146 from the disk 120 to determine the position of the transducing head 146 over one of a plurality of tracks on the disk 120. The servo system determines an appropriate current to drive through the voice coil 134, and drives the current through the voice coil 134 using a current driver and associated circuitry (shown in FIGS. 4 and 5). It should be noted that in some transducing head includes two separate elements. One element is for reading information representing data and reading positional information or servo information. This element is known as a read element. The other element, in these embodiments, is for writing information representing data and is known as a write element. One example of such a transducing head is a magnetoresistive (MR) transducing head.

Each side of a disk 120 can have an associated head 146, and the heads 146 are collectively coupled to the rotary actuator 130 such that the heads 146 pivot in unison. Typically the rotary actuator 130 and all of the heads 146 attached thereto are referred to as a head stack. The invention described herein is equally applicable to devices wherein the individual heads separately move some small distance relative to the actuator. This technology is referred to as dual-stage actuation (DSA).

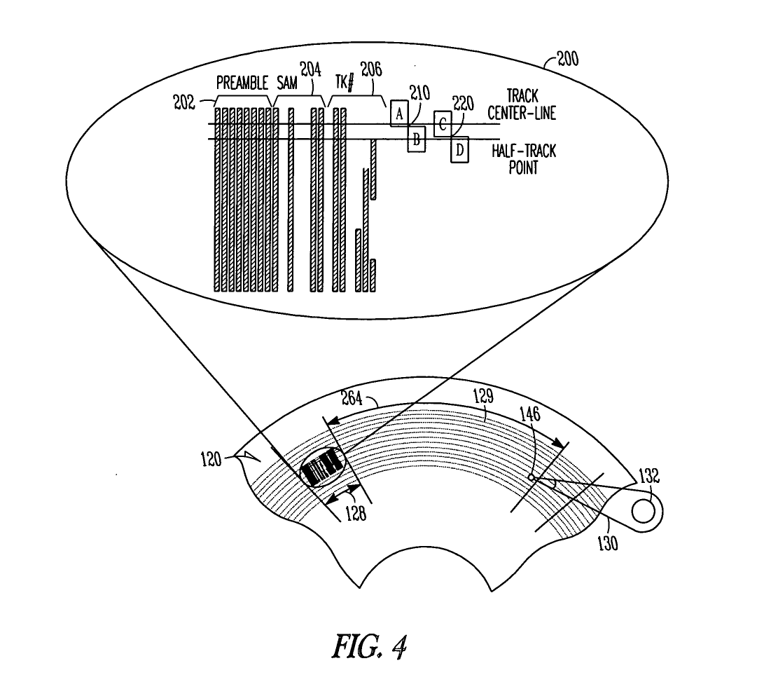

One type of servo system is an embedded, servo system in which tracks on each disk surface used to store information representing data contain small segments of servo information. The servo information, in some embodiments, is stored in radial servo sectors or servo wedges shown as several narrow, somewhat curved spokes 128 substantially equally spaced around the circumference of the disk 120. It should be noted that in actuality there may be many more servo wedges than as shown in FIG. 1. The servo wedges 128 are further detailed in FIGS. 3 and 4 and in the discussions associated with those FIGs.

The disk 120 also includes a plurality of tracks on each disk surface. The plurality of tracks is depicted by three tracks, such as track 129, 129′ and 129″ on the surface of the disk 120. The servo wedges 128 traverse the plurality of tracks, such as track 129, on the disk 120. The plurality of tracks, in some embodiments, may be arranged as a set of substantially concentric circles. Data is stored in fixed sectors along a track between the embedded servo wedges 128. The tracks on the disk 120 each include a plurality of data sectors. More specifically, a data sector is a portion of a track having a fixed block length and a fixed data storage capacity (e.g., 512 bytes of user data per data sector). The tracks toward the inside of the disk 120 are not as long as the tracks toward the periphery of the disk 110. As a result, the tracks toward the inside of the disk 120 can not hold as many data sectors as the tracks toward the periphery of the disk 120. Tracks that are capable of holding the same number of data sectors are grouped into a data zones. Since the density and data rates vary from data zone to data zone, the servo wedges 128 may interrupt and split up at least some of the data sectors. The servo sectors 128 are typically recorded with a servo writing apparatus at the factory (called a servo-writer), but may be written (or partially written) with the disk drive's 100 transducing head 146 in a self-servowriting operation.

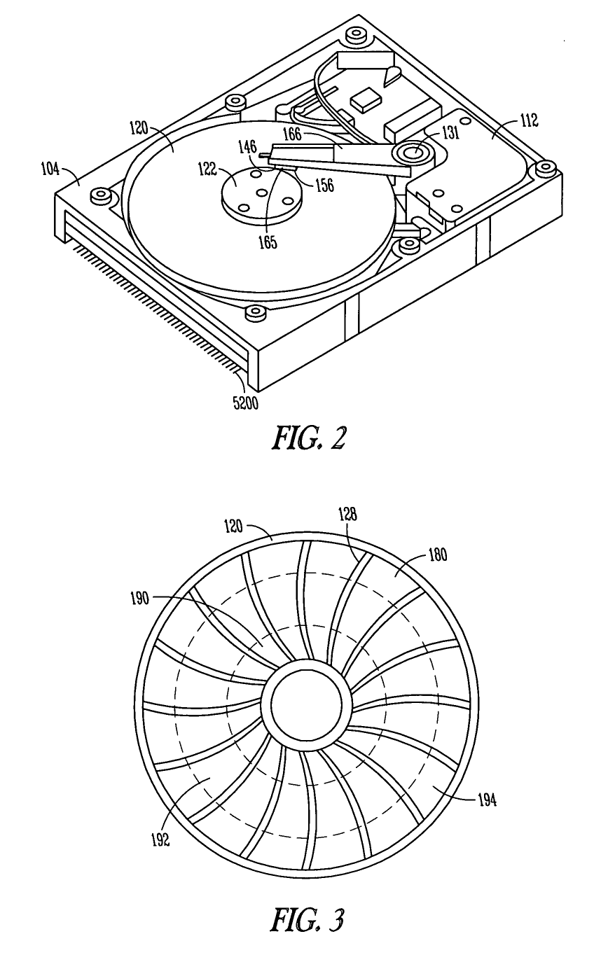

FIG. 2 is a perspective view of a substantially assembled disk drive, according to an example embodiment described herein. The housing cover 106 is removed for the sake illustration. In some embodiments, the disk drive 100 is a magnetic recording and reproducing apparatus (hard disk drive). The disk drive housing base 104 serves as a chassis. Mounted to the chassis or housing base 104 is a magnetic disk 120, a transducing head 146 including a read head and a write head. The transducing head 146 includes a slider 156. The read head and the write head are formed in and at one end of the slider 156, respectively. The slider 156 is attached to the actuator by a head suspension assembly 166. The head suspension assembly 166 includes a suspension 165 and an actuator arm 164 that supports the head slider 156 in transducing relation with the surface of the disk 120. Also attached to the housing base 104 or the chassis is a printed circuit board (PCB) 5200.

The magnetic disk 120 is a discrete track media. The magnetic disk 120 is mounted on a spindle 122 that is rotated by a spindle motor which typically is mounted within the hub or the spindle 122. Various digital data are recorded on the magnetic disk 120. In some embodiments, the data is recorded with magnetic transitions parallel to the major surface of the disk 120 while in other embodiments, the magnetic transitions are perpendicular to the major surface of the disk 120. In some embodiments, the magnetic head incorporated in the head slider 156 is a so-called integrated head including a write head of a single pole structure and a read head using a shielded MR read element (such as a GMR film or a TMR film). The voice coil motor (VCM) 112 drives the head suspension assembly about a pivot point 131 to position the magnetic head 156 at a radial position of the magnetic disk 120. The circuit board 108 comprises a head IC to generate driving signals for the voice coil motor (VCM) 112 and control signals for controlling read and write operations performed by the magnetic head 156.

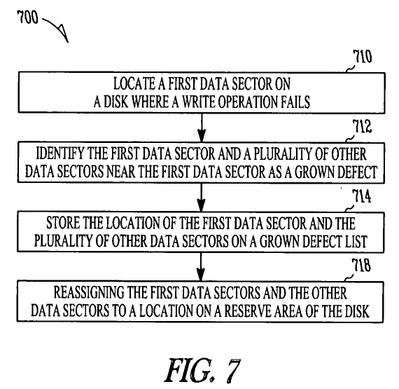

FIG. 3 is a schematic plan view of a magnetic disk 120 according to an example embodiment. FIG. 3 shows servo wedges 128 and data wedges 180 and servo wedges 128. User data is recorded in each of the data wedges 180. This example magnetic disk is a so-called DTR (discrete track recording) media having discrete tracks formed of concentric magnetic patterns. The recording tracks will be described later by way of example with reference to FIG. 6. Servo data for head positioning is formed in each of the servo wedges 128 as patterns of a magnetic material and a nonmagnetic material. On the disk surface, the servo wedges 128 are shaped like a circular arc corresponding to a locus of a head slider 156 during access. Each servo wedge 19 is formed so that its circumferential length is larger as its radial position is closer to its outermost periphery. The surface of the disk may have several zones. As shown in FIG. 3, there is an inner zone 190, a middle zone 192, and an outer zone 194. Data is typically stored along a track in a sector which stores a set amount of data, such as 512 bytes. Tracks in the outer zone 194 are longer and therefore can store more sectors between the servo wedges 128 than compared to the number of sectors that can be stored along a track at the inner zone 190. For example, if there are 10 sectors of data between adjacent servo wedges at the outer zone 194, there may be 4 or 5 sectors of data along a track in the inner zone 190. The servo wedges 128 typically traverse the zones 190, 192, and 194 without interruption. In some instances a servo wedge 128 may divide a sector of data.

FIG. 4 shows a portion of a disk 120 and at least one servo wedge 128, according to an example embodiment. FIG. 4 discusses further details related to the disk shown in FIG. 3. More specifically, FIG. 4 adds details related to the servo wedge 128 and shows a plurality of tracks on the surface of the disk 120. Each servo wedge 128 includes information stored as regions of magnetization. The servo wedge 128 can be longitudinally magnetized (for example, in the magnified portion of FIG. 4 a servo pattern 200 includes cross-hatched blocks magnetized to the left and white spaces magnetized to the right, or vice-versa) or alternatively perpendicularly magnetized (e.g., the cross-hatched blocks are magnetized up and the white spaces are magnetized down, or vice-versa). Servo patterns 200 contained in each servo wedge 128 are read by the transducing head 146 as the surface of the spinning disk 120 passes under the transducing head 146. The servo patterns 200 can include information identifying a data sector contained in a data field 264. For example, the servo pattern 200 can include digital information such as a preamble 202, a servo address mark (SAM) 204, a track identification number 206. The servo pattern 200 also includes a set of servo bursts. As shown in FIG. 2, the set of servo bursts include an A servo burst, a B servo burst, a C servo burst, and a D servo burst. There is a servo burst edge 210 between the A burst and the B burst, and a servo burst edge 220 between the C burst and the D burst. The pattern shown is a quadrature type pattern. In some embodiments, a disk drive will include a single column of each type of servo burst in each servo wedge 128. Each column corresponds to a radial of the disk. As shown in this embodiment, there are two columns of A, B, C, and D bursts which may be used in some embodiments. In some embodiments, the servo wedge 128 will also include other information such as a wedge number. This can be a single bit to designate an index wedge (wedge #0), or the SAM may be replaced by another pattern (referred to as a servo index mark or SIM), or the wedge may contain a few low-order bits of the wedge number or a complete wedge number. There are many different patterns for servo bursts, such as a null pattern.

This pattern shows four servo bursts and it should be understood that this may also be repeated in columns so as to produce several radial lines of AB and CD bursts on the disk in each servo wedge, such as servo wedge 128, on the disk. The servo burst pattern results in a servo burst edge 310 between the A and B servo bursts, and a servo burst edge 320 between the C and D servo bursts in the null pattern. In some embodiments, the disk 120 may be other than a magnetic disk. In such cases, the servo wedge 128 can include other indicia, such as optical indicia.

FIG. 5 shows a block diagram of the disk drive 100, according to an example embodiment. As shown, the disk drive includes a main body unit called a head disk assembly (HDA) 5100 and a printed circuit board (PCB) 5200.

Some details of the HDA 5100 have been discussed with respect to FIGS. 1 and 2. Therefore, the discussion of the HAD 5100 will refer to FIGS. 1, 2 and 5. The head disk assembly (HDA) 5100 includes the magnetic disk 120, the spindle motor 522 for rotating the spindle 122 (shown in FIGS. 1 and 2) and the magnetic disk 120, the head slider 156, including the read head and the write head, the suspension 165 and actuator arm 166, the voice coil motor (VCM) 112, and a head amplifier (HIC), which is not shown. The head slider 156 is provided with the read head such as a giant magnetoresistive (GMR) element and a write head, such as a thin film head formed on an end of the slider 156.

The head slider 156 may be attached to the suspension 165 a gimbal. The suspension 165 is attached to the actuator arm 166, which is rotatably attached to the pivot 131 (shown in FIG. 2). This figure shows the head slider 156 only above the top surface of the magnetic disk 120. It should be noted that generally a head slider is provided above the bottom and top surfaces of the magnetic disk 120, respectively. The voice coil motor (VCM) 112 generates a torque around the pivot 131 for the actuator arm 166 to rotate the head slider 156 over the surface of the disk 120. The head amplifier (HIC) is fixed to the actuator arm 166 to amplify input signals to and output signals from the write and read elements, respectively. The head amplifier (HIC) is connected to the printed circuit board (PCB) 5200 via a flexible print cable (FPC) 519. Placing the head amplifier (HIC) on the actuator arm 166 shortens the distance between the read head and the head amplifier and may effectively reduce noise in the head signals. However, in some embodiments, the head amplifier (HIC) may be fixed to the HDA main body, such as to the chassis or housing base 104.

As shown in FIG. 2, the printed circuit board 5200 is attached to the exterior of the chassis or housing base 104. Now turning to FIG. 5, the printed circuit board (PCB) 5200 includes four major electronic components, so-called system LSIs. The LSIs are mounted on the printed circuit board (PCB) 5200. The system LSIs are a head disk controller (HDC) 510, a read/write channel IC 520, a microprocessor unit (MPU) 530, and a motor driver IC 540.

The MPU 530 is a control unit of a driving system and includes a read only memory (ROM) 532, random access memory (RAM) 534, a central processing unit (CPU) 536, and a logic processing unit which implement a head positioning control system, according to the present example embodiment. The logic processing unit is an arithmetic processing unit that includes a hardware circuit to execute high-speed calculations. Firmware (FW) for the logic processing circuit is saved to the ROM 532. Firmware includes a set of instructions executable by the MPU 530 to control portions of the disk drive.

The disk controller (HDC) 510 is an interface unit in the hard disk drive which manages the whole drive by exchanging information with interfaces between the disk drive and a host computer 500 (for example, a personal computer) and with the MPU 530, read/write channel IC 520, and motor driver IC 540.

The read/write channel IC 520 is a head signal processing unit relating to read/write operations. The read/write channel IC 520 is shown as including a read/write path 512 and a servo demodulator 504. The read/write path 512, which can be used to read and write user data and servo data, may include front end circuitry useful for servo demodulation. The read/write path 512 may also be used for writing servo information in self-servowriting. It should be noted that the disk drive also includes other components, which are not shown because they are not necessary to explain the example embodiments.

The servo demodulator 504 is shown as including a servo phase locked loop (PLL) 526, a servo automatic gain control (AGC) 528, a servo field detector 531 and register space 532. The servo PLL 526, in general, is a control loop that is used to provide frequency and phase control for the one or more timing or clock circuits (not shown in FIG. 5), within the servo demodulator 504. For example, the servo PLL 526 can provide timing signals to the read/write path 512. The servo AGC 528, which includes (or drives) a variable gain amplifier, is used to keep the output of the read/write path 512 at a substantially constant level when servo wedges 128 on one of the disks 120 (shown in FIGS. 1-4) are being read. The servo field detector 531 is used to detect and/or demodulate the various subfields of the servo wedges 128, including a servo address mark (SAM), a track number, a first phase servo burst, and a second phase servo burst. The MPU 530 is used to perform various servo demodulation functions (e.g., decisions, comparisons, characterization and the like), and can be thought of as being part of the servo demodulator 504. In the alternative, the servo demodulator 504 can have its own microprocessor.

One or more registers (e.g., in register space 532) can be used to store appropriate servo AGC values (e.g., gain values, filter coefficients, filter accumulation paths, etc.) for when the read/write path 512 is reading servo data, and one or more registers can be used to store appropriate values (e.g., gain values, filter coefficients, filter accumulation paths, etc.) for when the read/write path 512 is reading user data. A control signal can be used to select the appropriate registers according to the current mode of the read/write path 512. The servo AGC value(s) that are stored can be dynamically updated. For example, the stored servo AGC value(s) for use when the read/write path 512 is reading servo data can be updated each time an additional servo wedge 128 is read. In this manner, the servo AGC value(s) determined for a most recently read servo wedge 128 can be the starting servo AGC value(s) when the next servo wedge 128 is read.

The read/write path 512 includes the electronic circuits used in the process of writing and reading information to and from the magnetic disks 120. The MPU 530 can perform servo control algorithms, and thus, may be referred to as a servo controller. Alternatively, a separate microprocessor or digital signal processor (not shown) can perform servo control functions.

FIG. 6 is a schematic diagram of a number of tracks in the first zone 190 and a number of tracks in the second zone 194 of a disk 120 from a disk drive, in which the tracks include data sectors positioned between servo information, according to an example embodiment.

As shown in FIG. 6 the tracks in zone 190 are all similar therefore only one track 601 from the first zone 190 will be discussed. Similarly, the tracks in zone 194 all have a similar arrangement of data sectors and therefore only one track 603 will be discussed. In each case, the tracks are actually curvilinear arcuate portions of the disk. However, for the sake of simplicity, the tracks such as track 603 and 601 are shown as linear in this schematic illustration. Track 601 is associated with the first zone 190. Track 601 includes three servo burst areas 128, 128′ and 128″. The servo wedges 128, 128′ and 128″ will include locational information or information that can be use to determine the exact location of the track 601, as shown or as further detailed in FIG. 4. Again, for the sake of simplicity, the servo wedges 128, 128′, and 128″ do not include representations of positional information. The track 601 also includes data sectors. Located between servo wedge 128 and servo wedge 128′ are data sectors 610, 611, 612, and 613. Located between servo wedge 128′ and servo wedge 128″ are data sectors 614, 615, 616, and 617. The data sectors are typically of a fixed length and therefore hold a fixed amount of data. In one example embodiment, the amount of data held is 512 bytes. The zone 190 is a zone which is toward the inner radius or inside of the disk since the distance between the server wedges 128, 128′ and 128″ is shorter than it would be in an outer region of the disk. Therefore, at the inner region of disk the distance between the servo wedges 128, 128′ and 128″ are closer together since the concentric circle representing the track is shorter at an inner portion of the disk when compared to an outer portion of the disk. It should be noted, that the servo wedges 128, 128′ and 128″ are contiguous or on radials that begin at the inner diameter and then at the outer diameter of the disk, as shown in FIGS. 2 through 4. Track 603 is in zone 194. Zone 194 is a different zone than zone 190. Track 603 also shows the same servo wedges 128, 128′ and 128″. However, since zone 194 is positioned more toward the outer perimeter of the disk the linear distance between the servo wedges 128, 128′ and 128″ is greater in zone 194 than in zone 190. As a result more data sectors can be placed between sector 128 and sector 128′ in the outer zone or zone 194 than in zone 190. Track 603 includes data sectors 630, 631, 632, 633, 634, 636, and 637 located between servo wedge 128 and servo wedge 128′. Track 603 also includes a split sector which means that a portion of the sector 638 is located between servo wedge 128 and servo wedge 128′ and another portion of the servo sector 138 is located between servo wedge 128′ and servo wedge 128″. In some instances, it is necessary to split the data sector so as to keep the servo wedge 128′ contiguous from zone to zone. In addition to a portion of the split data sector 638, data sectors 639, 640, 641, 642, 643, 644, and 645 are located between servo wedges 128′ and 128″. The transducing head or read head moves with respect to the disk 120 in the direction depicted by arrow 620 in FIG. 6.

When writing the information to a disc it is necessary to know the exact position of the write head so that it can be assured that the write head is positioned over the desired track on the disk. One embodiment of the invention, the position of the write head is qualified or double checked with the servo system. In other words, when looking at track 601 after writing a data sector 610 the position of the write head is post qualified or double checked by looking at the servo information in sector 128′. In other words, the servo wedge 128 is first read to determine if the write head location is on track 601, the sector 610 is then written on track 601 and then after the writing of data sector 610 the location of the write head is double checked by reading the servo information in servo wedge 128′ to make sure that the write head is on track 601. Checking the location of the track 601 using the information associated with the servo wedge 128′ is also termed as post-qualifying the write operation. There can be many reasons why the information in servo wedge 128 may not be able to verify the location of write head. For example, a servo address mark may not be able to be read. There are also other reasons why the servo information contained in servo wedge 128′ may not be able to be read or used to post-qualify the write to data sector 610. If the location of the write head cannot be post-qualified, the disk drive system attempts to rewrite the data sector 610 a number of times. Generally a number of attempts will be made to rewrite the data sector. If on one of the attempts the write operation to data sector 610 is completed then the write commands includes that data sector can be marked as complete and the system can notify the host that a write command including data sector 610 is complete. On the other hand, if a number of retries are attempted and all fail then a defect, also known as a grown defect, is identified. It should be noted that the information representing data may or may not be written correctly to the disk 120. In some instances, the data may not be written at all. The nature of the defect is that the servo wedge after the write can not be read to confirm the location of the write.

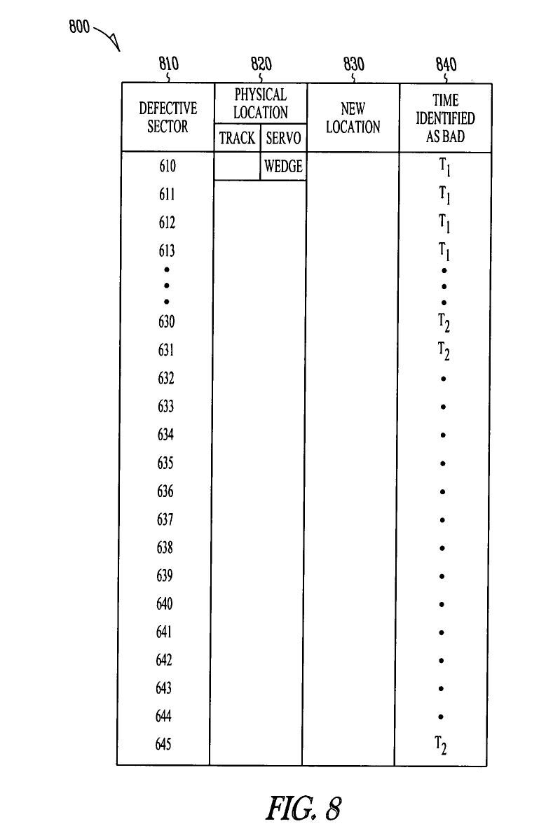

FIG. 7 is a flowchart of a method 700 for determining a write defect and placing the defect onto a defect list 800, according to an example embodiment. The initial step is to locate a first data sector on a disc where a write operation fails, as depicted by reference number 710. As mentioned above, one reason for identifying a data sector where a write operation fails because a post-qualify operation for determining the position of the write head after writing to a particular data sector cannot be complete. There may be other reasons for write failure as well. The particular data sector where the write operation fails will be considered defective. In this particular embodiment, other data sectors related to the first data sector will also be identified as defective or as a grown defect, as depicted by a block 712. In other words, rather than going through the steps of identifying a data sector as defective which includes a number of retries and verifications for each data sector, a plurality of other data sectors located near the first data sector that is identified wherein a write operation fails are also marked or determined to be part of the grown defect.

The plurality of other data sectors is related to the number of data sectors located between a first servo wedge 128 and a second servo wedge 128′ on the disk 120. Identifying the plurality of other data sectors 712 may be related to the number of data sectors located between a first servo wedge 128 and a second servo wedge 128′ on the disk 120. The first data sector is located between the first servo wedge 128 and the second servo wedge 128′. In one embodiment, the first servo wedge 128 and the second servo wedge 128 are consecutive servo wedges on the disk and the other data sectors are located between first servo wedge 128 and the second servo wedge 128′. In still another embodiment, the other data sectors include the other sectors in the track associated with the first data sector 128. The other data sectors are located between first servo wedge and the second servo wedge 128, and between the second servo wedge 128′ and a third servo wedge 128″. In one embodiment, the first servo wedge 128, the second servo wedge 128′, and the third servo wedge 128″ are consecutive servo wedges on the disk.

The location of the first data sector and the plurality of other data sectors related to the first one are then placed on or stored in a grown defect list, as depicted by block 714. For example, as shown in FIG. 6 if block 610 is determined or identified as being a grown defect where the disk drive is unable to successfully complete a write operation to that particular data sector then the other data sectors near there were it is likely also that they would be unable to be written to are also identified as part of the grown defect. For example, on FIG. 6 at track 601, when data sector 610 is identified as unable to be written to the other data sectors in the data wedge or in between servo wedges 128 and 128′ are also identified as part of the grown defect. For example, the other data sector 611, 612 and 613 are also identified as part of the grown defect. Thus, the data sector 610, 611, 612 and 613 would be stored on a grown defect list. Once physical data sectors located on the disk have been identified as grown defects the data sectors will be skipped in response to later write commands. There will be no LBA that corresponds to the physical location of these data sectors. In other words, these particular data sectors will have been reassigned to sectors in a reserve area of the disk, as depicted by reference numeral 718. Therefore and in subsequent write commands, the grown defect list will be used to identify the sectors which cannot be written to and to redirect the write head to an area of the reserve area on the disc where the reassigned sectors corresponding to data sector 610 to 613 reside. Therefore on a subsequent write command that would include data sectors 610 to 613 on track 601 the write command will be completed after skipping the actual physical data sectors 610, 611, 612 and 613 and writing those sectors to the reassigned sectors in the reserve area of the disc.

In another embodiment of the invention, an additional amount of data sectors may be associated with the first data sector that is identified as being incapable of being written to. For example, in FIG. 6 when looking at track 603 data sector 632 may be identified as a data sector which cannot be written to. A number of retries are attempted until a threshold number of retries is met. When the number of threshold retries has been attempted and failed then data sector 632 would be marked as a grown defect. In this particular embodiment of the invention, a number of data sectors related to data sector 632 or near data sector 632 would also be placed on the grown defect list. In this particular embodiment, the grown defect would include the data sectors 631 to 645. In other words, the data sectors that would be included would be the original sector that was found to include a write defect, 632, as well as the data sectors between servo wedges 128′ and 128″ as well as the data sectors between servo wedges 128 and 128′. In this manner, the grown defect includes the split sector 638. In other words, by including the data sectors between the three servo wedges 128″, 128′ and 128 the split data sector 638 is also identified as a grown defect and placed on the grown defect list. This prevents having only a part of sector 638, namely that portion of sector 638 between servo wedge 128 and 128′ as being capable of writing to for future write commands. In other words, by going back to servo wedges (128 and 128′) and identifying all of those data sectors between the servo wedge 128 and the servo wedge 128″ it eliminates any problems of writing to a split data sector, such as split data sector 638. By grouping or identifying a related data sector to a first data sector that is identified as being a grown defect, the disk drive saves time in determining the extent of the grown defect over a system where each sector is tried and retried and then identified as a grown defect.

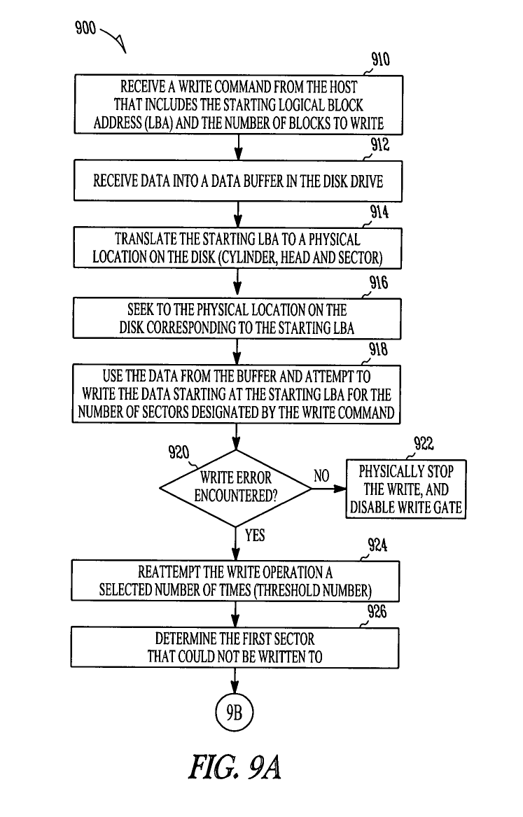

FIG. 8 is a grown defect listing that is generally stored in memory associated with the MPU 530 (shown in FIG. 5). Grown defect list shown in FIG. 8 includes a column for the defective sector as depicted by reference numeral 810. A column for the physical location of that defective sector as depicted by reference number 820 where a column for the new location as depicted by reference numeral 830 and the time that the defective sector was identified as a grown defect as depicted by reference numeral 840. The defective sector as shown in the grown defect list 800 is shown as a number that corresponds to the reference numbers shown in FIG. 6. However, typically this will not be a number like that shown in FIG. 6 but will be an LBA or logical block address. The logical block address is an address for a sector on a disk drive that can be used by a host computer or a controller within the disk drive to identify a logical sector. Logical block addresses are then mapped to an actual physical location. Thus, once a sector is identified as a grown defect and placed on a grown defect list the logical block address will be noted the physical location of that logical block address as a grown defect will be noted in column 820 and then the new location or reassigned location in the reserve area of the disk will be identified by column 830. So, for example, if a logical block address needs to be written to and that logical block address corresponds to the previously identified defective sector which is shown as 610 the old physical location associated with that defective sector will be identified by column 820 and skipped and a new logical block address in the reserve area will identified as the place where that logical block can be written to. In other words, the grown defect list also contains a mapping for a particular logical block address from an old physical location to a new physical location in a reserve area of the disc. The grown defect list 800 shown in FIG. 8 also includes a time that the defective sector was identified as a grown defect or identified as bad. It should be noted that in this particular embodiment, many of the grown defects are identified as bad or as grown defects at the same time as depicted by a number of times having the valued T₁. A number of other times correspond to T₂ for several other of the defective sectors on the grown defective sector list. It should also be noted that the grown defect list is not necessarily a physical list such as shown in FIG. 8 but is actually a set of pointers located within the memory associated with the MPU 530 (as shown FIG. 5). It should be noted that the grown defect list 800 can be included in one memory or can be distributed over several memories associated with the disk drive.

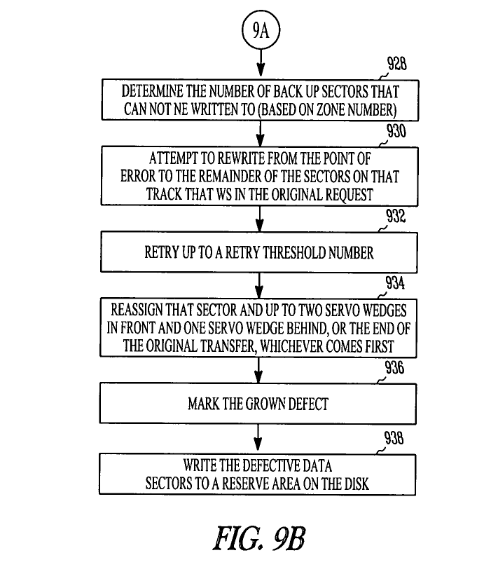

FIGS. 9A and 9B show a flow chart of a method 900 for determining a write defect and placing the defect onto the defect list, according to an example embodiment. Initially, a write command from the host that includes the starting logical block address (LBA) and the number of blocks to write is received, as depicted by block 910. The disk drive also receives the data associated with the write command and places the data in a data buffer, as depicted by block 912. A pointer for the start of the data in the buffer is also generated. At some point in time, depending on write caching, the number of read commands, and other factors, the disk drive system will execute the write command. The buffer pointer, the LBA and the number of blocks is the information the disk drive needs to execute the write command. The LBA is translated to a physical address (cylinder number, head number, and sector number) on one of the major surfaces of the disk drive, as depicted by block 914.

A seek is then conducted to the physical location on the surface of the disk, as depicted by block 916. When the seek completes data is removed from the buffer and an attempt to write the data sectors starting at the given LBA (now converted to an actual physical location) is conducted, as depicted by block 918. A determination of a write error is depicted by block 920. If no write errors are encountered the write of the data in the commanded number of sectors is completed, the write is stopped and the write gate is disabled, as depicted by block 922. If there is a write error, then a number of reattempts to write are conducted to a selected number of times, as depicted by block 924. A write error occurs when the next servo wedge that comes along after the number of data sectors are written can not be used to qualify or double check that the write was done correctly. In on embodiment, the servo wedges have a value which identifies the track called the servo address mark which may not be read by the read head. This value is used to qualify or double check the write to make sure it can be said that the write is to the track associated with the physical address that is associated with the LBA.

If the write can not be verified, in the middle of a write command, the servo will disable the write operation. If the write command completed before it could be verified, the write gate will already be disabled. In either case, reattempts to write the end of the data or the intermediate portion of the data associated with the write command will be reattempted a number of times. The first sector that could not be written to will be determined. Then a number of back up sectors for the write is determined, as depicted by block 928. The number of back up sectors makes sure that the total amount of information representing data in the write command is written correctly. In one embodiment, the number of back up data sectors is selected to be an amount equal to two servo wedges. This means that the amount of the back up data is equal to an amount of data that could be post written qualified by two servo wedges. Since the track length between servo wedges is longer at outer diameter of the disk drive than at the inner diameter of the disk drive, the number of data sectors between servo wedges varies based on the zone number.

An attempt to rewrite from the point of error to the remainder of the sectors on that track that was in the original request, as depicted by block 930, is then conducted. Retries are made up to a retry threshold number, as depicted by block 932. When the threshold number of retries is met, a number of sectors will be reassigned, as depicted by block 934. The number of sectors that will be reassigned is equal to up to two servo wedges in front of the servo wedge and one servo wedge behind the servo wedge that can not be read to qualify a write, or to the end of the original transfer, whichever comes first. The number that we reassign is dependant on where the bad sector is in relationship to both the end of the requested transfer and the servo sector that is bad. These data sectors are then marked as bad and will be placed on the grown defect list, as depicted by block 936. The defective sectors are then written to a reserve area of the disk, as depicted by 938.

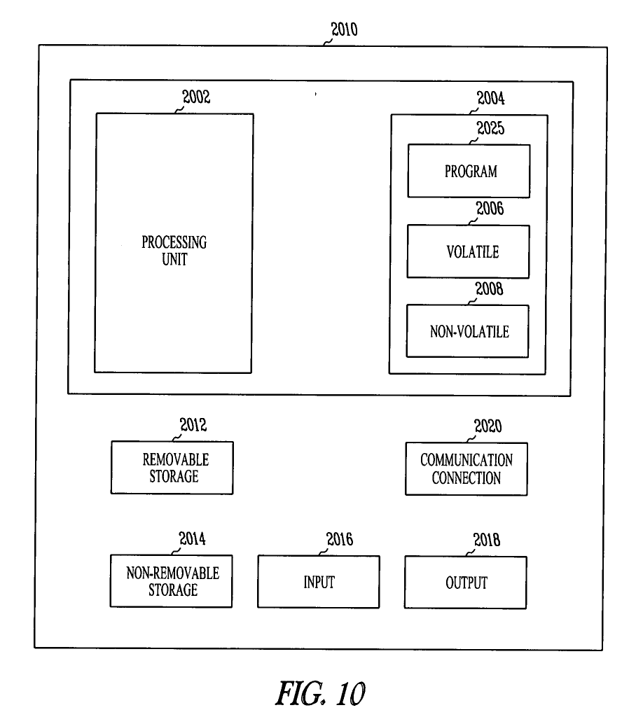

A block diagram of a computer system that executes programming for performing the above algorithm is shown in FIG. 10. A general computing device, in the form of a computer 2010, may include a processing unit 2002, memory 2004, removable storage 2012, and non-removable storage 2014. Memory 2004 may include volatile memory 2006 and non volatile memory 2008. Computer 2010 may include—or have access to a computing environment that includes—a variety of computer-readable media, such as volatile memory 2006 and non-volatile memory 2008, removable storage 2012 and non-removable storage 2014. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 2010 may include or have access to a computing environment that includes input 2016, output 2018, and a communication connection 2020. The computer may operate in a networked environment using a communication connection to connect to one or more remote computers. The remote computer may include a personal computer (PC), server, router, network PC, a peer device or other common network node, or the like. The communication connection may include a Local Area Network (LAN), a Wide Area Network (WAN) or other networks. The microprocessor 210 or other selected circuitry or components of the disk drive may be such a computer system.

Computer-readable instructions stored on a computer-readable medium are executable by the processing unit 2002 of the computer 2010. A hard drive, CD-ROM, and RAM are some examples of articles including a computer-readable medium. The machine-readable medium provides instructions that, when executed by a machine, cause the machine to perform operations that include locating a first data sector on a disk where a write operation fails, identifying the first data sector and a plurality of other data sectors near the first data sector as a grown defect, and storing the location of the first data sector and the plurality of other data sectors on a grown defect list. In one embodiment, the operation of identifying the plurality of other data sectors further includes identifying data sectors located in the same track on the disk as the first data sector. The machine readable medium may also execute instructions which cause the operation of identifying the plurality of other data sectors that is related to the number of data sectors located between a first servo wedge and a second servo wedge on the disk. In one embodiment, the first data sector located between the first servo wedge and the second servo wedge.

The foregoing description of the specific embodiments reveals the general nature of the invention sufficiently that others can, by applying current knowledge, readily modify and/or adapt it for various applications without departing from the generic concept, and therefore such adaptations and modifications are intended to be comprehended within the meaning and range of equivalents of the disclosed embodiments.

It is to be understood that the phraseology or terminology employed herein is for the purpose of description and not of limitation. Accordingly, the invention is intended to embrace all such alternatives, modifications, equivalents and variations as fall within the spirit and broad scope of the appended claims.

What is claimed is:

1. A method for writing comprising:
locating a first data sector on a disk where a write operation fails;
identifying the first data sector and a plurality of other data sectors near the first data sector as a defect; and
storing the location of the first data sector and the plurality of other data sectors on a defect list.

2. The method of claim 1 wherein identifying the plurality of other data sectors includes identifying data sectors located in the same track on the disk as the first data sector.

3. The method of claim 1 wherein identifying the plurality of other data sectors is related to the number of data sectors located between a first servo wedge and a second servo wedge on the disk.

4. The method of claim 1 wherein identifying the plurality of other data sectors is related to the number of data sectors located between a first servo wedge and a second servo wedge on the disk, the first data sector located between the first servo wedge and the second servo wedge.

5. The method of claim 4 wherein the first servo wedge and the second servo wedge are consecutive servo wedges on the disk, the first data sector located between the first servo wedge and the second servo wedge.

6. The method of claim 4 wherein the plurality of other data sectors includes the other data sectors in the track associated with the first data sector, the other data sectors located between first servo wedge and the second servo wedge.

7. The method of claim 4 wherein the plurality of other data sectors include the other sectors in the track associated with the first data sector, the other data sectors located between first servo wedge and the second servo wedge, and between the second servo wedge and a third servo wedge.

8. The method of claim 7 wherein the first servo wedge, the second servo wedge, and the third servo wedge are consecutive servo wedges on the disk.

9. The method of claim 6 further comprising skipping the data sectors on the track between a first servo wedge and a second servo wedge in responding to a subsequent write command.

10. The method of claim 1 further comprising reassigning the first data sector and the other data sectors to a location on a reserve area of the disk.

11. A disk drive comprising:
a disk for storing information representing data, the disk further including:
a plurality of concentric tracks;
a first servo wedge including servo information crossing the plurality of concentric tracks;
a second servo wedge including servo information crossing the plurality of concentric tracks; and
data sectors to store data associated with the tracks, the data sectors positioned between the first servo wedge and a second servo wedge; and
a memory device that includes a list of defects to identify a plurality of data sectors stored along a track between the first servo wedge and the second servo wedge on a selected track as data sectors which may not be written to.

12. The disk drive of claim 11 wherein the memory device is configured to identify the plurality of data sectors stored along a track as bad at substantially the same time.

13. The disk drive of claim 11 wherein the memory device includes an entry to identify the plurality of sectors as grown defects.

14. The disk drive of claim 11 wherein the disk further comprises a third servo wedge including servo information crossing the plurality of concentric tracks and wherein the memory device is configured to identify the data sectors along the track between the second servo wedge and third servo wedge on the selected track as data sectors which may not be written to.

15. The disk drive of claim 14 wherein the memory device is configured to identify the plurality of data sectors stored along a track between the first servo wedge and the second servo wedge and between the second servo wedge and the third servo wedge as bad at substantially the same time.

16. The disk drive of claim 14 wherein the memory device includes an entry to identify the plurality of data sectors stored along a track between the first servo wedge and the second servo wedge and between the second servo wedge and the third servo wedge as grown defects.

17. A machine-readable medium that provides instructions that, when executed by a machine, cause the machine to:
locate a first data sector on a disk where a write operation fails;
identify the first data sector and a plurality of other data sectors near the first data sector as a grown defect; and
store the location of the first data sector and the plurality of other data sectors on a grown defect list.

18. The machine readable medium of claim 17 wherein to identify the plurality of other data sectors further includes identifying data sectors located in the same track on the disk as the first data sector.

19. The machine readable medium of claim 17 wherein to identify the plurality of other data sectors is related to the number of data sectors located between a first servo wedge and a second servo wedge on the disk.

20. The machine readable medium of claim 17 wherein to identify the plurality of other data sectors is related to the number of data sectors located between a first servo wedge and a second servo wedge on the disk, the first data sector located between the first servo wedge and the second servo wedge.
